(19) United States
(12) Patent Application Publication
(10) Pub. No.: US 2025/0207368 A1
(43) Pub. Date: Jun. 26, 2025

(54) MEASUREMENT SYSTEM OF WORK MACHINE, WORK MACHINE, AND MEASUREMENT METHOD OF WORK MACHINE

(71) Applicant: Komatsu Ltd., Tokyo (JP)

(72) Inventors: Azumi Ichikawa, Tokyo (JP); Yosuke Uchida, Tokyo (JP); Yuki Shimano, Tokyo (JP)

(73) Assignee: Komatsu Ltd., Tokyo (JP)

(21) Appl. No.: 18/847,309

(22) PCT Filed: Aug. 30, 2023
(86) PCT No.: PCT/JP2023/031532

§ 371 Date: Sep. 16, 2024

(30) Foreign Application Priority Data
Sep. 26, 2022 (JP) 2022-152569

(51) Int. Cl. E02F 9/26

(52) U.S. Cl. CPC E02F 9/262; E02F 9/265

(57) ABSTRACT

Disclosed is a measurement system of a work machine, the measurement system including: a position calculation unit that calculates a position of the work machine based on detection data of a position sensor; a working equipment position calculation unit that calculates a position of working equipment provided in the work machine based on the position of the work machine; a construction data storage unit that stores a position of a point predetermined at a work site of the work machine; and a distance calculation unit that calculates a distance between the position of the point and the position of the working equipment.

### FIELD

The present disclosure relates to a measurement system of a work machine, the work machine, and a measurement method of the work machine.

### BACKGROUND

In a technical field related to a work machine, an excavation machine as disclosed in Patent Literature 1 is disclosed.

### CITATION LIST

### Patent Literature

Patent Literature 1: JP 2014-074318 A

### SUMMARY

### Technical Problem

There is a demand for measuring a distance between two points that working equipment of a work machine cannot reach at a work site. For example, there is a demand for a technique capable of measuring a distance between two points in a place such as a river where it is difficult for the work machine or a worker to enter.

An object of the present disclosure is to measure a distance between two points that working equipment cannot reach.

### Solution to Problem

In order to achieve an aspect of the present invention, a measurement system of a work machine, the measurement system comprises: a position calculation unit that calculates a position of the work machine based on detection data of a position sensor; a working equipment position calculation unit that calculates a position of working equipment provided in the work machine based on the position of the work machine; a construction data storage unit that stores a position of a point predetermined at a work site of the work machine; and a distance calculation unit that calculates a distance between the position of the point and the position of the working equipment.

### Advantageous Effects of Invention

According to the present disclosure, it is possible to measure a distance between two points that working equipment cannot reach.

### BRIEF DESCRIPTION OF DRAWINGS

FIG. 1 is a perspective view illustrating a work machine according to an embodiment.

FIG. 2 is a schematic diagram illustrating the work machine according to the embodiment.

FIG. 3 is a diagram illustrating a cab of the work machine according to the embodiment.

FIG. 4 is a block diagram illustrating a control system of the work machine according to the embodiment.

FIG. 5 is a diagram illustrating a work screen displayed on a display device according to the embodiment.

FIG. 6 is a flowchart illustrating a measurement method of a distance between a position of a point and a position of working equipment according to the embodiment.

FIG. 7 is a transition diagram of a measurement screen displayed on a display device in measurement of the distance between the position of the point and the position of the working equipment according to the embodiment.

FIG. 8 is a transition diagram of the measurement screen displayed on the display device in measurement of the distance between the position of the point and the position of the working equipment according to the embodiment.

FIG. 9 is a block diagram illustrating a computer system according to the embodiment.

### DESCRIPTION OF EMBODIMENTS

Hereinafter, embodiments according to the present disclosure will be described with reference to the drawings, but the present disclosure is not limited to the embodiments. The components of the embodiments described below can be appropriately combined with each other. In addition, some components may not be used.

### [Work Machine]

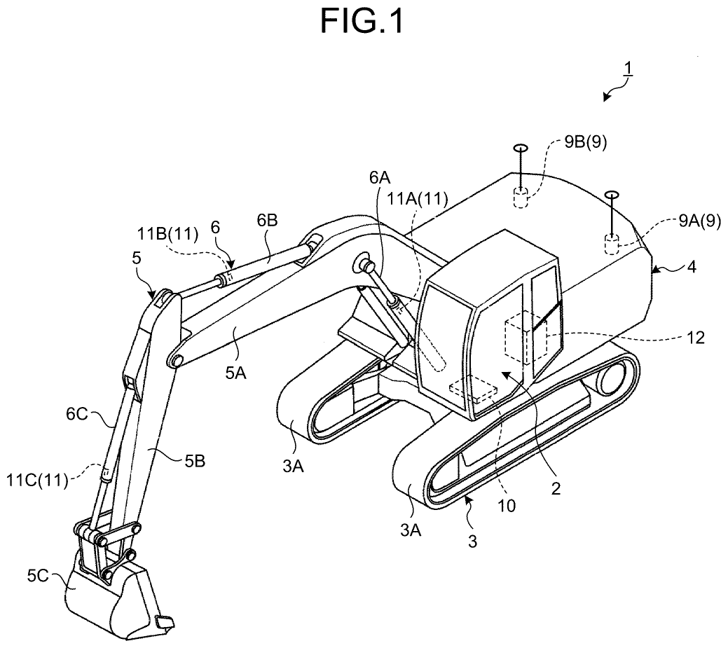

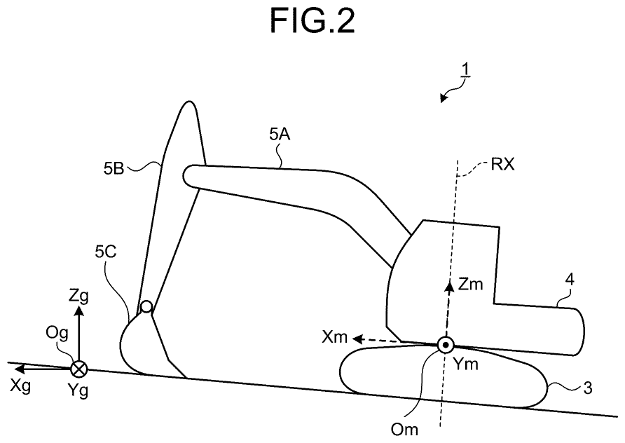

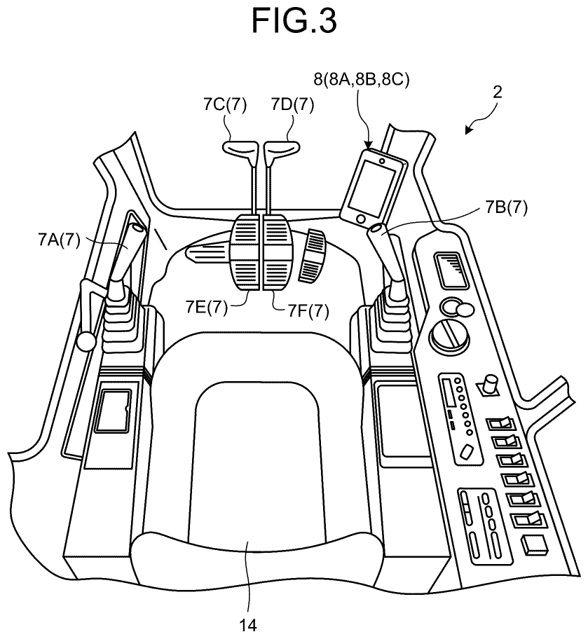

FIG. 1 is a perspective view illustrating a work machine 1 according to an embodiment. FIG. 2 is a schematic diagram illustrating the work machine 1 according to the embodiment. FIG. 3 is a diagram illustrating a cab 2 of the work machine 1 according to the embodiment.

The work machine 1 is operated at a work site. In the embodiment, the work machine 1 is an excavator. In the following description, the work machine 1 is appropriately referred to as an excavator 1.

The excavator 1 includes a traveling body 3, a swing body 4, working equipment 5, a hydraulic cylinder 6, an operating device 7, an in-vehicle monitor 8, a position sensor 9, an inclination sensor 10, a posture sensor 11, and a control device 12.

As illustrated in FIG. 2, a three-dimensional site coordinate system (Xg, Yg, Zg) is defined at the work site. A three-dimensional vehicle body coordinate system (Xm, Ym, Zm) is defined in the swing body 4.

The site coordinate system is configured by an Xg axis extending from a site reference point Og defined at the work site to the north and south, a Yg axis extending from the site reference point Og to the east and the west, and a Zg axis extending vertically from the site reference point Og.

The vehicle body coordinate system is configured by an Xm axis extending in the forward-and-rearward direction of the swing body 4 from a representative point Om defined in the swing body 4, a Ym axis extending in the left-and-right direction of the swing body 4 from the representative point Om, and a Zm axis extending in the upward-and-downward direction of the swing body 4 from the representative point Om. With reference to the representative point Om of the swing body 4, the +Xm direction is the front side of the swing body 4, the −Xm direction is the rear side of the swing body 4, the +Ym direction is the left side of the swing body 4, the −Ym direction is the right side of the swing body 4, the +Zm direction is the upper side of the swing body 4, and the −Zm direction is the lower side of the swing body 4.

The traveling body 3 travels while supporting the swing body 4. The traveling body 3 includes a pair of crawler belts 3A. By the rotation of the crawler belts 3A, the traveling body 3 performs traveling movement. The traveling movement of the traveling body 3 includes forward movement and rearward movement. The excavator 1 can move within the work site by the traveling body 3.

The swing body 4 is supported by the traveling body 3. The swing body 4 is disposed above the traveling body 3. The swing body 4 performs swing movement around a swing axis RX while being supported by the traveling body 3. The swing axis RX is parallel to the Zm axis. The swing movement of the swing body 4 includes a left swing movement and a right swing movement. The cab 2 is provided in the swing body 4.

The working equipment 5 is supported by the swing body 4. The working equipment 5 performs work. In the embodiment, the work performed by the working equipment 5 includes excavation work of excavating an excavation object and loading work of loading an excavated object onto a loading object.

The working equipment 5 includes a boom 5A, an arm 5B, and a bucket 5C. The proximal end portion of the boom 5A is rotatably connected to a front portion of the swing body 4. The proximal end portion of the arm 5B is rotatably connected to the distal end portion of the boom 5A. The proximal end portion of the bucket 5C is rotatably connected to the distal end portion of the arm 5B.

The hydraulic cylinder 6 causes the working equipment 5 to move. The hydraulic cylinder 6 includes a boom cylinder 6A, an arm cylinder 6B, and a bucket cylinder 6C. The boom cylinder 6A causes the boom 5A to perform a raising movement and a lowering movement. The arm cylinder 6B causes the arm 5B to perform an excavation movement and a dumping movement. The bucket cylinder 6C causes the bucket 5C to perform the excavation movement and the dumping movement. The proximal end portion of the boom cylinder 6A is connected to the swing body 4. The distal end portion of the boom cylinder 6A is connected to the boom 5A. The proximal end portion of the arm cylinder 6B is connected to the boom 5A. The distal end portion of the arm cylinder 6B is connected to the arm 5B. The proximal end portion of the bucket cylinder 6C is connected to the arm 5B. The distal end portion of the bucket cylinder 6C is connected to the bucket 5C.

As illustrated in FIG. 3, the operating device 7 is disposed in the cab 2. The operating device 7 is operated to cause at least one of the traveling body 3, the swing body 4, and the working equipment 5 to move. The operating device 7 is operated by an operator in the cab 2. The operator can operate the operating device 7 while sitting on a driver seat 14 disposed in the cab 2.

The operating device 7 includes a left working lever 7A and a right working lever 7B operated for the movement of the swing body 4 and the working equipment 5, a left traveling lever 7C and a right traveling lever 7D operated for the movement of the traveling body 3, and a left foot pedal 7E and a right foot pedal 7F.

When the left working lever 7A is operated in the forward-and-rearward direction, the arm 5B performs the dumping movement or the excavation movement. When the left working lever 7A is operated in the left-and-right direction, the swing body 4 performs the left swing movement or the right swing movement. When the right working lever 7B is operated in the left-and-right direction, the bucket 5C performs the excavation movement or the dumping movement. When the right working lever 7B is operated in the forward-and-rearward direction, the boom 5A performs the lowering movement or the raising movement. Note that the swing body 4 may perform the left swing movement or the right swing movement when the left working lever 7A is operated in the forward-and-rearward direction, and the arm 5B may perform the dumping movement or the excavation movement when the left working lever 7A is operated in the left-and-right direction.

When the left traveling lever 7C is operated in the forward-and-rearward direction, the crawler belt 3A on the left side of the traveling body 3 performs the forward movement or the rearward movement. When the right traveling lever 7D is operated in the forward-and-rearward direction, the crawler belt 3A on the right side of the traveling body 3 performs the forward movement or the rearward movement.

The left foot pedal 7E is operated in conjunction with the left traveling lever 7C. The right foot pedal 7F is operated in conjunction with the right traveling lever 7D. The traveling body 3 may perform the forward movement or the rearward movement by operating the left foot pedal 7E and the right foot pedal 7F.

The in-vehicle monitor 8 is disposed in the cab 2. The in-vehicle monitor 8 is disposed on the right front side of the driver seat 14. The in-vehicle monitor 8 includes a display device 8A, an input device 8B, and an alarm device 8C.

The display device 8A displays prescribed display data. As the display device 8A, a flat panel display such as a liquid crystal display (LCD) or an organic electroluminescence display (OELD) is exemplified.

The input device 8B generates input data by being operated by the operator. Examples of the input device 8B include a button switch, a computer keyboard, and a touch panel.

The alarm device 8C outputs a prescribed alarm. In the embodiment, the alarm device 8C is a sound output device that outputs an alarm sound. Note that the alarm device 8C may be a light emitting device that outputs alarm light.

The position sensor 9 detects the position of the swing body 4 in the site coordinate system. The position sensor 9 detects the position of the swing body 4 in the site coordinate system using a global navigation satellite system (GNSS). The global navigation satellite system includes a global positioning system (GPS). The global navigation satellite system detects a position defined by coordinate data of latitude, longitude, and altitude. The position sensor 9 includes a GNSS receiver that receives GNSS radio waves from a GNSS satellite. The position sensor 9 is disposed in the swing body 4. In the embodiment, the position sensor 9 is disposed in a counterweight of the swing body 4.

The position sensor 9 includes a first position sensor 9A and a second position sensor 9B. The first position sensor 9A and the second position sensor 9B are disposed at different positions in the swing body 4. In the embodiment, the first position sensor 9A and the second position sensor 9B are disposed at intervals in the left-and-right direction in the swing body 4. The first position sensor 9A detects a first measured position indicating a position in which the first position sensor 9A is disposed. The second position sensor 9B detects a second measured position indicating a position in which the second position sensor 9B is disposed.

The inclination sensor 10 detects acceleration and angular velocity of the swing body 4. The inclination sensor 10 includes an inertial measurement unit (IMU). The inclination sensor 10 is disposed in the swing body 4. In the embodiment, the inclination sensor 10 is installed below the cab 2.

The posture sensor 11 detects the posture of the working equipment 5. The posture of the working equipment includes an angle of the working equipment 5. The posture sensor 11 includes a first posture sensor 11A that detects an angle of the boom 5A relative to the swing body 4, a second posture sensor 11B that detects an angle of the arm 5B relative to the boom 5A, and a third posture sensor 11C that detects an angle of the bucket 5C relative to the arm 5B. The posture sensor 11 may be a stroke sensor that detects a stroke of the hydraulic cylinder 6 or a potentiometer that detects the angle of the working equipment 5.

### [Control System]

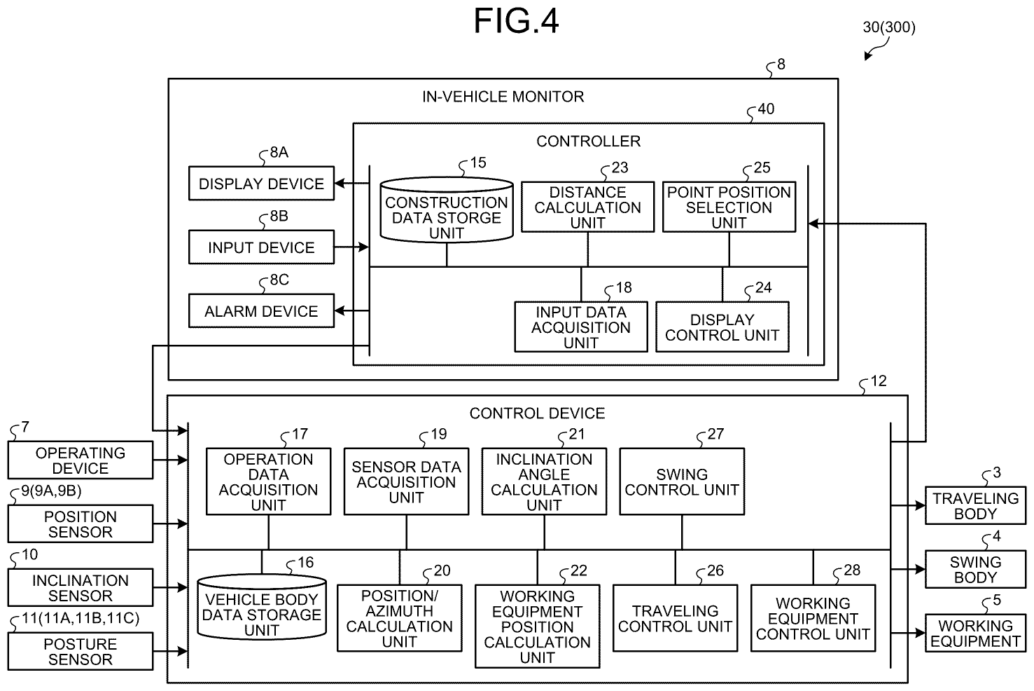

FIG. 4 is a block diagram illustrating a control system 30 of the work machine 1 according to the embodiment. The excavator 1 includes the control system 30. The control system 30 includes a measurement system 300. The control system 30 includes the in-vehicle monitor 8, the position sensor 9, the inclination sensor 10, the posture sensor 11, and the control device 12. The control device 12 controls the excavator 1. The control device 12 includes a computer system.

The in-vehicle monitor 8 includes a controller 40. The controller 40 includes a construction data storage unit 15, an input data acquisition unit 18, a distance calculation unit 23, a display control unit 24, and a point position selection unit 25.

The control device 12 includes a vehicle body data storage unit 16, an operation data acquisition unit 17, a sensor data acquisition unit 19, a position/azimuth calculation unit 20, an inclination angle calculation unit 21, a working equipment position calculation unit 22, a traveling control unit 26, a swing control unit 27, and a working equipment control unit 28.

The construction data storage unit 15 stores a design surface defined in the work site. The design surface is created by a computer system existing outside the excavator 1. The design surface is created in an external facility of the excavator 1, such as a design room. The design surface is a surface defined in the site coordinate system. Target terrain data of the work site is defined by a plurality of design surfaces. The excavator 1 constructs the work site based on the target terrain data.

In addition, the construction data storage unit stores a position of a point predetermined at the work site. The position of the point is defined in a site coordinate system. The construction data storage unit 15 stores each of positions of a plurality of points. The position of the point is acquired by, for example, surveying work. For example, three-dimensional data of a topography of a construction site may be measured by a three-dimensional sensor, and each of a plurality of positions on a surface of the topography of the work site defined by the three-dimensional data may be stored in the construction data storage unit 15 as a position of a point. In the embodiment, the construction data storage unit 15 stores a position preset at the work site as a position of a point.

The vehicle body data storage unit 16 stores vehicle body data of the excavator 1. The vehicle body data of the excavator 1 includes dimensions of the working equipment 5. The dimensions of the working equipment 5 include a length of the boom 5A, a length of the arm 5B, and a length of the bucket 5C. In addition, the vehicle body data of the excavator 1 includes dimensions of the traveling body 3 and dimensions of the swing body 4.

The operation data acquisition unit 17 acquires operation data generated by operating the operating device 7.

The input data acquisition unit 18 acquires input data generated by operating the input device 8B.

The sensor data acquisition unit 19 acquires detection data of the position sensor 9, detection data of the inclination sensor 10, and detection data of the posture sensor 11.

The position/azimuth calculation unit 20 calculates a position and an azimuth angle of the swing body 4 in the site coordinate system based on the detection data of the position sensor 9. As described above, the position sensor 9 includes the GNSS receiver that receives GNSS radio waves. The position/azimuth calculation unit 20 calculates the position and the azimuth angle of the swing body 4 based on the GNSS radio waves. The azimuth angle of the swing body 4 is, for example, an azimuth angle of the swing body 4 based on the Xg axis.

The position/azimuth calculation unit 20 calculates the position of the swing body 4 based on at least one of the first measured position detected by the first position sensor 9A and the second measured position detected by the second position sensor 9B. The position/azimuth calculation unit 20 calculates the azimuth angle of the swing body 4 based on a relative position between the first measured position detected by the first position sensor 9A and the second measured position detected by the second position sensor 9B.

The inclination angle calculation unit 21 calculates an inclination angle of the swing body 4 based on the detection data of the inclination sensor 10. The inclination angle of the swing body 4 includes a roll angle and a pitch angle of the swing body 4. The roll angle refers to an inclination angle of the swing body 4 in an inclination direction around the Xg axis. The pitch angle refers to an inclination angle of the swing body 4 in an inclination direction around the Yg axis. The inclination angle calculation unit 21 calculates the roll angle and the pitch angle of the swing body 4 based on the detection data of the inclination sensor 10.

The working equipment position calculation unit 22 calculates a position of the working equipment 5 based on the position of the work machine 1 calculated by the position/azimuth calculation unit 20. In the embodiment, the working equipment position calculation unit 22 calculates the position of the working equipment 5 in the site coordinate system based on the vehicle body data of the excavator 1 stored in the vehicle body data storage unit 16, the position and azimuth angle of the swing body 4 calculated by the position/azimuth calculation unit 20, the inclination angle of the swing body 4 calculated by the inclination angle calculation unit 21, and the detection data of the posture sensor 11. The position of the working equipment 5 includes the position of the bucket 5C. The position of the bucket 5C includes the position of a distal end portion (a blade edge) of the bucket 5C.

The distance calculation unit 23 calculates a distance between the position of the point stored in the construction data storage unit 15 and the position of the working equipment 5 calculated by the working equipment position calculation unit 22. As described above, each of the position of the point and the position of the working equipment 5 is defined in the site coordinate system. Therefore, the distance calculation unit 23 can calculate the distance between the position of the point and the position of the working equipment 5 in the site coordinate system.

The distance calculation unit 23 calculates the distance by setting one position of the position of the point and the position of the working equipment 5 as a start point, and setting the other position as an end point.

As the distance between the position of the point and the position of the working equipment 5, the distance calculation unit 23 can calculate a straight line distance between the position of the point and the position of the working equipment 5, a horizontal distance between the position of the point and the position of the working equipment 5, and a vertical distance between the position of the point and the position of the working equipment 5. In addition, the distance calculation unit 23 can calculate an inclination angle (gradient) of a line connecting the position of the point to the position of the working equipment 5 relative to the horizontal plane.

The distance calculation unit 23 calculates the distance based on the input data from the input device 8B. An operator of the excavator 1 in the cab 2 can operate the input device 8B and select a point to be used for calculation of the distance from among the plurality of points.

The point position selection unit 25 selects a point to be used for calculation of a distance from among a plurality of points. The point position selection unit 25 selects the point to be used for calculation of the distance from among the plurality of points stored in the construction data storage unit 15 based on the input data generated by operating the input device 8B.

The display control unit 24 controls the display device 8A of the in-vehicle monitor 8. The display control unit 24 causes the display device 8A to display prescribed display data. In the embodiment, the display control unit 24 causes the display device 8A to display the distance calculated by the distance calculation unit 23. In addition, the display control unit 24 causes the display device 8A to display a gradient of a line connecting the position of the point to the position of the working equipment 5 calculated by the distance calculation unit 23.

The traveling control unit 26 controls the traveling body 3 based on the operation data of the operating device 7 acquired by the operation data acquisition unit 17.

The swing control unit 27 controls the swing body 4 based on the operation data of the operating device 7 acquired by the operation data acquisition unit 17.

The working equipment control unit 28 controls the working equipment 5 based on the operation data of the operating device 7 acquired by the operation data acquisition unit 17.

### [Work Screen]

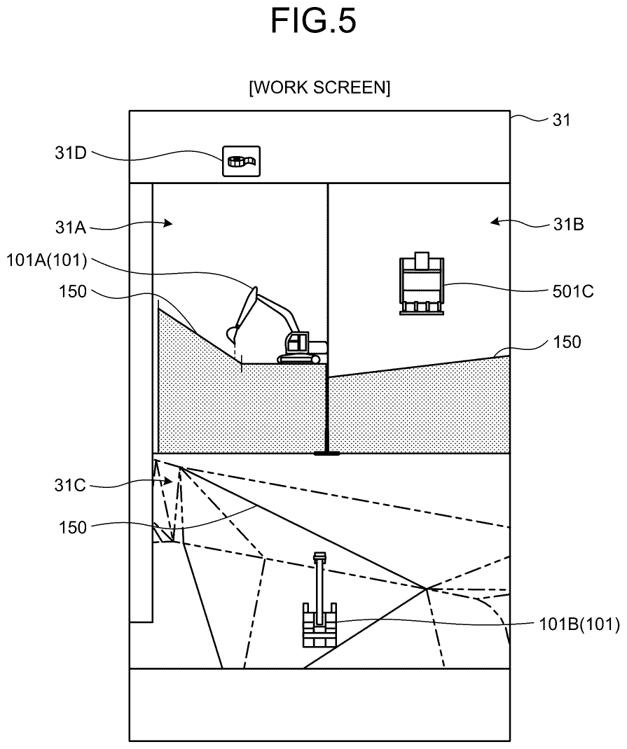

FIG. 5 is a diagram illustrating a work screen 31 displayed on the display device 8A according to the embodiment. While the excavator 1 is performing excavation work, the display control unit 24 causes the display device 8A to display the work screen 31. As illustrated in FIG. 5, a display area 31A, a display area 31B, and a display area 31C are defined on the work screen 31.

On the work screen 31, a symbol image 101 indicating the excavator 1 is displayed. The symbol image 101 of the excavator 1 includes a first symbol image 101A indicating the excavator 1 when the work site is viewed from the side in the site coordinate system, and a second symbol image 101B indicating the excavator 1 when the work site is viewed from above in the site coordinate system.

In the display area 31A, the first symbol image 101A indicating the excavator 1 when the work site is viewed from the side and a target construction surface 150 when the work site is viewed from the side are displayed.

In the display area 31B, a symbol image 501C indicating the bucket 5C and the target construction surface 150 indicating a target shape of a work object are displayed. In the display area 31B, the symbol image 501C when the bucket 5C is viewed from the rear side and the target construction surface 150 are displayed.

In the display area 31C, the second symbol image 101B indicating the excavator 1 when the work site is viewed from above and the target construction surface 150 when the work site is viewed from above are displayed.

The display control unit 24 can arbitrarily change a viewpoint of the symbol image 101 displayed in each of the display area 31A and the display area 31C. The display control unit 24 can arbitrarily change a viewpoint of the symbol image 501C displayed in the display area 31B. The display control unit 24 can arbitrarily change a viewpoint of the target construction surface 150 displayed in each of the display area 31A, the display area 31B, and the display area 31C. For example, the display control unit 24 may display, in the display area 31A, the second symbol image 101B indicating the excavator 1 when the work site is viewed from above and the target construction surface 150 when the work site is viewed from above. In addition, one or two of the display area 31A, the display area 31B, and the display area 31C may be displayed on the work screen 31.

When the operating device 7 is operated and at least one of the traveling body 3 and the swing body 4 moves, the target construction surface 150 is changed on the work screen 31 in conjunction with at least one of the traveling body 3 and the swing body 4. For example, when the swing body 4 faces the south, the target construction surface 150 when the excavator 1 is viewed from the east side is displayed in the display area 31C. When the swing body 4 faces the east due to the swing of the swing body 4, the target construction surface 150 when the excavator 1 is viewed from the north side is displayed in the display area 31C.

When the operating device 7 is operated and the working equipment 5 moves, the position of the symbol image 501C and the posture of the working equipment in the symbol image 101 change on the work screen 31 in conjunction with the working equipment 5. The operator of the excavator 1 can operate the operating device 7 while checking the work screen 31 so that the bucket 5C of the working equipment 5 moves along the target construction surface 150. The display control unit 24 can assist the operation of the operator by displaying the work screen 31 on the display device 8A.

### [Measurement Screen]

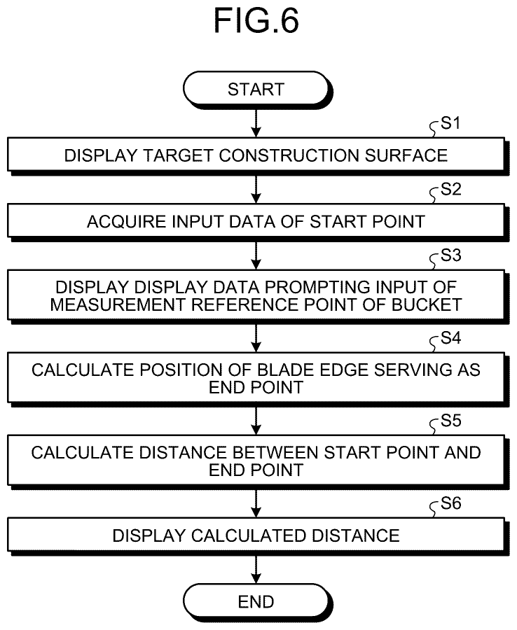

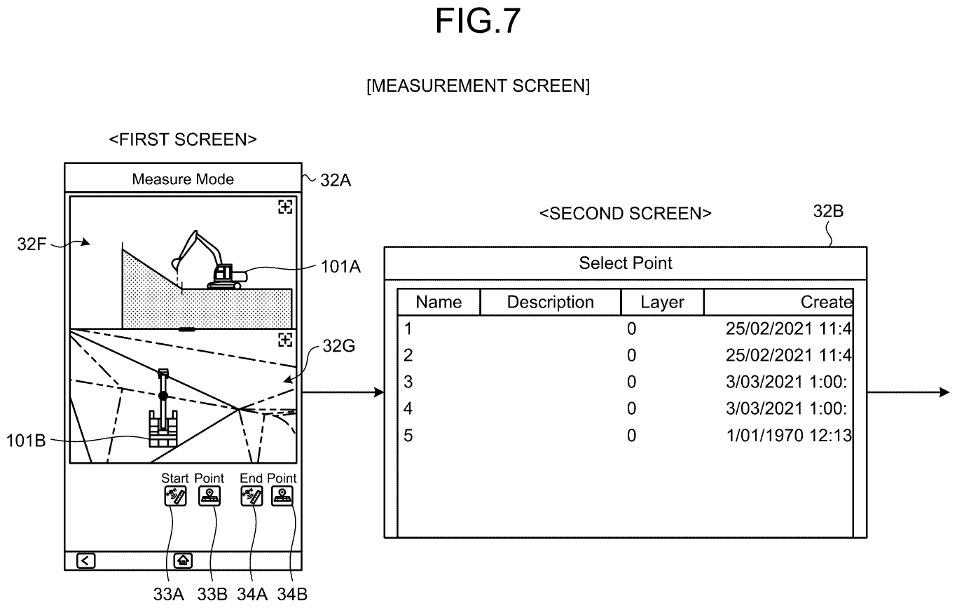

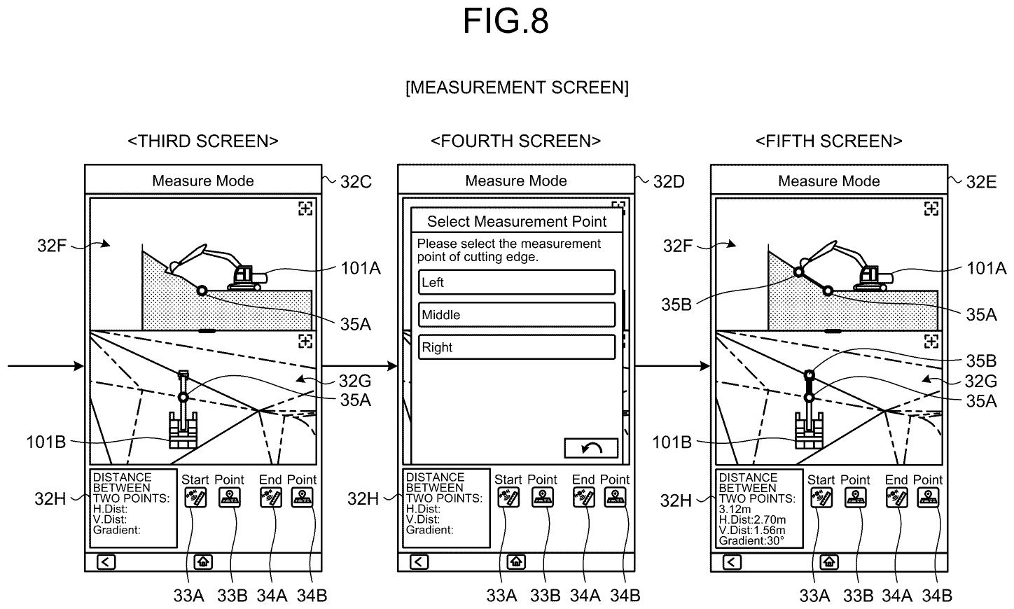

FIG. 6 is a flowchart illustrating a measurement method of a distance between a position of a point and a position of the working equipment 5 according to the embodiment. Each of FIGS. 7 and 8 is a transition diagram of a measurement screen 32 displayed on the display device 8A in the measurement of the distance between the position of the point and the position of the working equipment 5 according to the embodiment. On the measurement screen 32, the first symbol image 101A indicating the excavator 1 when the work site is viewed from the side and the second symbol image 101B indicating the excavator 1 when the work site is viewed from above are displayed.

In the measurement of the distance, the display control unit 24 causes the display device 8A to display the measurement screen 32. When the measurement screen 32 is selected by an operator on a menu screen (not illustrated), the display control unit 24 can display the measurement screen 32 on the display device 8A.

As illustrated in FIG. 7, a display area 32F and a display area 32G are defined on a first screen 32A of the measurement screen 32. In the display area 32F, the first symbol image 101A indicating the excavator 1 when the work site is viewed from the side and the target construction surface 150 are displayed. In the display area 32G, the second symbol image 101B indicating the excavator 1 when the work site is viewed from above and the target construction surface 150 are displayed (Step S1).

A start point button 33A and a start point button 33B that are operated to designate a start point when a distance between two points is measured at the work site, and an end point button 34A and an end point button 34B that are operated to designate an end point are displayed at a lower portion of the first screen 32A. By operating the start point button 33A, the position of the working equipment 5 is designated as a start point when a distance between two points is measured. By operating the start point button 33B, a position of a point preset at the work site is designated as a start point when a distance between two points is measured. By operating the end point button 34A, the position of the working equipment 5 is designated as an end point when a distance between two points is measured. By operating the end point button 34B, a position of a point preset at the work site is designated as an end point when a distance between two points is measured.

When the position of the working equipment 5 is set as the start point, the operator operates the operating device 7 to adjust the position of the working equipment 5 and designate the start point, and then operates the start point button 33A. When the position of the point preset at the work site is set as the start point, the operator operates the start point button 33B. Here, it is assumed that the position of the point is designated as the start point. When the start point button 33B is operated, each of the positions of the plurality of points preset at the work site is displayed on a second screen 32B. The operator designates a position of an arbitrary point as a start point from among the positions of the plurality of points displayed on the second screen 32B.

The input device 8B is operated by tapping the second screen 32B. The input data acquisition unit 18 acquires input data of the start point generated by operating the input device 8B (Step S2).

The point position selection unit 25 selects the point to be used for calculation of the distance from among the plurality of points stored in the construction data storage unit 15 based on the input data generated by operating the input device 8B. The point position selection unit 25 selects a point corresponding to the position designated on the second screen 32B. The display control unit 24 causes the display device 8A to display a start point symbol 35A indicating the position of the point serving as the start point. By tapping the second screen 32B, the start point is confirmed. When the start point is confirmed, the measurement screen 32 transitions from the second screen 32B to a third screen 32C.

Note that the operator may operate the input device 8B to designate a start point when a distance between two points is measured. When the input device 8B includes a touch panel, the operator may tap an arbitrary position on the first screen 32A.

When the position of the working equipment 5 is set as the end point, the operator operates the operating device 7 to adjust the position of the working equipment 5 and designate the end point, and then operates the end point button 34A. When the position of the point preset at the work site is set as the end point, the operator operates the end point button 34B. Here, it is assumed that the position of the working equipment 5 is designated as the end point. The operator operates the operating device 7 to position the blade edge of the bucket 5C at an arbitrary position at the work site.

When the end point button 34A is operated after the blade edge of the bucket 5C is positioned at the arbitrary position at the work site, the display control unit 24 causes the display device 8A to display display data prompting an input of a measurement reference point of the bucket 5C (Step S3).

The measurement reference point of the bucket 5C is set to any one of a left portion, a center portion, and a right portion of the blade edge of the bucket 5C in a vehicle width direction. On a fourth screen 32D, character data of “Left”, “Middle”, and “Right” are displayed. The operator selects “Left” when setting the measurement reference point of the bucket 5C to the left portion of the blade edge. The operator selects “Middle” when setting the measurement reference point of the bucket 5C to the center portion of the cutting edge. The operator selects “Right” when setting the measurement reference point of the bucket 5C to the right portion of the blade edge.

When the measurement reference point of the bucket 5C is selected, the measurement screen 32 transitions from the fourth screen 32D to a fifth screen 32E. In the display area 32F of the fifth screen 32E, the first symbol image 101A indicating the excavator 1 when the work site is viewed from the side and the target construction surface 150 are displayed. In the display area 32G of the fifth screen 32E, the second symbol image 101B indicating the excavator 1 when the work site is viewed from above and the target construction surface 150 are displayed.

When the measurement reference point of the bucket 5C is selected, the working equipment position calculation unit 22 calculates the position of the blade edge of the bucket 5C in the site coordinate system. The working equipment position calculation unit 22 calculates the position of the measurement reference point of the bucket 5C designated in Step S3 (Step S4).

The distance calculation unit 23 calculates a distance between the position of the point, that is the start point designated in Step S3, and the position of the measurement reference point of the bucket 5C, that is the end point calculated in Step S4 (Step S5).

The display control unit 24 causes the display device 8A to display an end point symbol 35B indicating the position of the measurement reference point of the bucket 5C serving as the end point. In addition, the display control unit 24 displays the distance calculated by the distance calculation unit 23 in Step S5 in a display area 32H of the fifth screen 32E (Step S6).

The display control unit 24 causes the display area 32H to display, as the distance between the position of the point and the position of the working equipment 5, a straight line distance between the position of the point and the position of the working equipment 5, a horizontal distance between the position of the point and the position of the working equipment 5, and a vertical distance between the position of the point and the position of the working equipment 5. In addition, the display control unit 24 causes the display area 32H to display a gradient of a line connecting the position of the point to the position of the working equipment 5.

A description has been given as to an example in which the position of the point is designated as the start point, and the position of the working equipment 5 is designated as the end point. The position of the working equipment 5 may be designated as a start point, and the position of the point may be designated as an end point. Further, the position of the point may be designated as a start point and an end point. The position of the working equipment 5 may be designated as a start point and an end point. When the position of the working equipment 5 is designated as the start point, the display control unit 24 causes the display device 8A to display display data prompting an input of the measurement reference point of the bucket 5C by operating the start point button 33A. When the position of the point is designated as the end point, the end point button 34B is operated to display the fifth screen 32E.

### [Computer System]

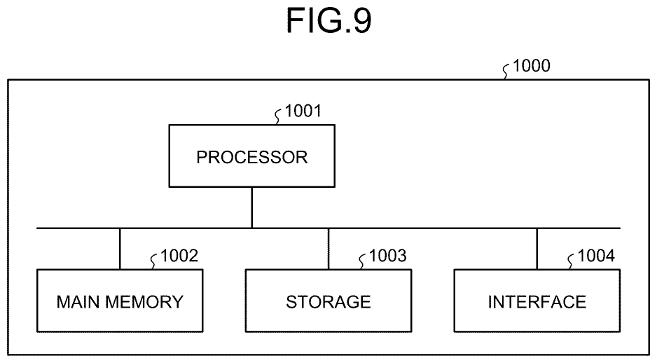

FIG. 9 is a block diagram illustrating a computer system 1000 according to the embodiment. The control device 12 described above includes the computer system 1000. The computer system 1000 includes a processor 1001 such as a central processing unit (CPU), a main memory 1002 including a nonvolatile memory such as a read only memory (ROM) and a volatile memory such as a random access memory (RAM), a storage 1003, and an interface 1004 including an input/output circuit. The function of the control device 12 described above is stored in the storage 1003 as a computer program. The processor 1001 reads the computer program from the storage 1003, loads the computer program in the main memory 1002, and executes the above-described processing according to the program. Note that the computer program may be distributed to the computer system 1000 via a network.

According to the above-described embodiment, the computer program or the computer system 1000 can execute: calculating the position of the excavator 1 based on the detection data of the position sensor 9; calculating the position of the working equipment 5 provided in the excavator 1 based on the position of the excavator 1; storing the position of a point predetermined at the work site of the excavator 1; and calculating the distance between the position of the point and the position of the working equipment 5.

### [Effects]

As described above, the measurement system 300 of the excavator 1 according to the embodiment includes: the position/azimuth calculation unit 20 that calculates the position of the excavator 1 based on the detection data of the position sensor 9; the working equipment position calculation unit 22 that calculates the position of the working equipment 5 provided in the excavator 1 based on the position of the excavator 1; the construction data storage unit 15 that stores the position of a point predetermined at the work site of the excavator 1; and the distance calculation unit 23 that calculates the distance between the position of the point and the position of the working equipment 5.

According to the embodiment, when measuring the distance between two points at the work site, the position of the point preset at the work site is designated as one of the start point and the end point, whereby the measurement system 300 can measure the distance between the two points even if the working equipment 5 of the excavator 1 does not reach one of the start point and the end point.

### Other Embodiments

In the above-described embodiment, the construction data storage unit 15 stores the position preset at the work site as the position of the point. The construction data storage unit 15 may store the position of the working equipment 5 calculated by the working equipment position calculation unit 22 as the position of the point. That is, the position of the point stored in the construction data storage unit 15 may be detected in advance by a predetermined three-dimensional sensor, or may be calculated using the blade edge of the bucket 5C.

In the above-described embodiment, each of the construction data storage unit 15, the vehicle body data storage unit 16, the operation data acquisition unit 17, the input data acquisition unit 18, the sensor data acquisition unit 19, the position/azimuth calculation unit 20, the inclination angle calculation unit 21, the working equipment position calculation unit 22, the distance calculation unit 23, the display control unit 24, the point position selection unit 25, the traveling control unit 26, the swing control unit 27, and the working equipment control unit 28 may be configured by separate hardware.

In the above-described embodiment, the work machine 1 is an excavator including the traveling body 3 and the swing body 4. The work machine 1 may not include the traveling body 3 and the swing body 4. The work machine 1 only needs to have a working equipment, and may be, for example, a bulldozer or a wheel loader.

### REFERENCE SIGNS LIST

1 EXCAVATOR (WORK MACHINE)
2 CAB
3 TRAVELING BODY
3A CRAWLER BELT
4 SWING BODY
5 WORKING EQUIPMENT
5A BOOM
5B ARM
5C BUCKET
6 HYDRAULIC CYLINDER
6A BOOM CYLINDER
6B ARM CYLINDER
6C BUCKET CYLINDER
7 OPERATING DEVICE
7A LEFT WORKING LEVER
7B RIGHT WORKING LEVER
7C LEFT TRAVELING LEVER
7D RIGHT TRAVELING LEVER
7E LEFT FOOT PEDAL
7F RIGHT FOOT PEDAL
8 IN-VEHICLE MONITOR
8A DISPLAY DEVICE
8B INPUT DEVICE
8C ALARM DEVICE
9 POSITION SENSOR
9A FIRST POSITION SENSOR
9B SECOND POSITION SENSOR
10 INCLINATION SENSOR
11 POSTURE SENSOR
11A FIRST POSTURE SENSOR
11B SECOND POSTURE SENSOR
11C THIRD POSTURE SENSOR
12 CONTROL DEVICE
14 DRIVER SEAT
15 CONSTRUCTION DATA STORAGE UNIT
16 VEHICLE BODY DATA STORAGE UNIT
17 OPERATION DATA ACQUISITION UNIT
18 INPUT DATA ACQUISITION UNIT
19 SENSOR DATA ACQUISITION UNIT
20 POSITION/AZIMUTH CALCULATION UNIT
21 INCLINATION ANGLE CALCULATION UNIT
22 WORKING EQUIPMENT POSITION CALCULATION UNIT
23 DISTANCE CALCULATION UNIT
24 DISPLAY CONTROL UNIT
25 POINT POSITION SELECTION UNIT
26 TRAVELING CONTROL UNIT
27 SWING CONTROL UNIT
28 WORKING EQUIPMENT CONTROL UNIT
30 CONTROL SYSTEM
31 WORK SCREEN
31A DISPLAY AREA
31B DISPLAY AREA
31C DISPLAY AREA
32 MEASUREMENT SCREEN
32A FIRST SCREEN
32B SECOND SCREEN
32C THIRD SCREEN
32D FOURTH SCREEN
32E FIFTH SCREEN
32F DISPLAY AREA
32G DISPLAY AREA
32H DISPLAY AREA
33A START POINT BUTTON
33B START POINT BUTTON
34A END POINT BUTTON
34B END POINT BUTTON
35A START POINT SYMBOL
35B END POINT SYMBOL
101 SYMBOL IMAGE
101A FIRST SYMBOL IMAGE
101B SECOND SYMBOL IMAGE
150 TARGET CONSTRUCTION SURFACE
300 MEASUREMENT SYSTEM
501C SYMBOL IMAGE
1000 COMPUTER SYSTEM
1001 PROCESSOR
1002 MAIN MEMORY
1003 STORAGE
1004 INTERFACE
Og SITE REFERENCE POINT
Om REPRESENTATIVE POINT
RX SWING AXIS

1. A measurement system of a work machine, the measurement system comprising:
a position calculation unit that calculates a position of the work machine based on detection data of a position sensor;
a working equipment position calculation unit that calculates a position of working equipment provided in the work machine based on the position of the work machine;
a construction data storage unit that stores a position of a point predetermined at a work site of the work machine; and
a distance calculation unit that calculates a distance between the position of the point and the position of the working equipment.

2. The measurement system of a work machine according to claim 1, wherein
the distance calculation unit calculates the distance by setting one position of the position of the point and the position of the working equipment as a start point and setting the other position as an end point.

3. The measurement system of a work machine according to claim 1, wherein
the construction data storage unit stores each of positions of a plurality of the points, and
the measurement system further comprises a point position selection unit that selects a point to be used for calculation of the distance from among the plurality of points.

4. The measurement system of a work machine according to claim 1, wherein
the construction data storage unit stores a position preset at the work site as the position of the point.

5. The measurement system of a work machine according to claim 1, wherein
the construction data storage unit stores the position of the working equipment calculated by the working equipment position calculation unit as the position of the point.

6. The measurement system of a work machine according to claim 1, wherein
the distance includes a straight line distance between the position of the point and the position of the working equipment, a horizontal distance between the position of the point and the position of the working equipment, and a vertical distance between the position of the point and the position of the working equipment.

7. The measurement system of a work machine according to claim 1, wherein
the distance calculation unit calculates an inclination angle of a line connecting the position of the point to the position of the working equipment relative to a horizontal plane.

8. The measurement system of a work machine according to claim 1, further comprising
a display control unit that causes a display device to display the distance calculated by the distance calculation unit.

9. A work machine comprising
the measurement system of a work machine according to claim 1.

10. A measurement method of a work machine, the method comprising:
calculating a position of the work machine based on detection data of a position sensor;
calculating a position of working equipment provided in the work machine based on the position of the work machine;
storing a position of a point predetermined at a work site of the work machine; and
calculating a distance between the position of the point and the position of the working equipment.

11. The measurement method of a work machine according to claim 10, wherein
the distance is calculated by setting one position of the position of the point and the position of the working equipment as a start point and setting the other position as an end point.

12. The measurement method of a work machine according to claim 10, wherein
each of positions of a plurality of the points is stored, and
a point to be used for calculation of the distance is selected from among the plurality of points.

13. The measurement method of a work machine according to claim 10, wherein
a position preset at the work site is stored as the position of the point.

14. The measurement method of a work machine according to claim 10, wherein
the position of the working equipment calculated based on the position of the working equipment is stored as the position of the point.

15. The measurement method of a work machine according to claim 10, wherein
the distance includes a straight line distance between the position of the point and the position of the working equipment, a horizontal distance between the position of the point and the position of the working equipment, and a vertical distance between the position of the point and the position of the working equipment.

16. The measurement method of a work machine according to claim 10, wherein
an inclination angle of a line connecting the position of the point to the position of the working equipment relative to a horizontal plane is calculated.

17. The measurement method of a work machine according to claim 10, further comprising
causing a display device to display the calculated distance.
